(19) United States
(12) Patent Application Publication
(10) Pub. No.: US 2026/0261176 A1
(43) Pub. Date: Sep. 3, 2026

(54) MOTOR

(71) Applicant: LG INNOTEK CO., LTD., Seoul (KR)

(72) Inventor: Young Hwan JUNG, Seoul (KR)

(73) Assignee: LG INNOTEK CO., LTD., Seoul (KR)

(21) Appl. No.: 18/857,987

(22) PCT Filed: Apr. 21, 2023
(86) PCT No.: PCT/KR2023/005457

§ 371 Date: Oct. 18, 2024

(30) Foreign Application Priority Data
Apr. 21, 2022 (KR) 10-2022-0049325

(51) Int. Cl. H02K 5/16

(52) U.S. Cl. CPC H02K 5/16

(57) ABSTRACT

Disclosed is motor including: a shaft; a rotor coupled to the shaft, and a stator disposed corresponding to the rotor; a housing accommodating the stator; a bearing supporting the shaft and a bearing housing supporting the bearing, wherein the housing includes a first body, a first flange, and a junction connecting the first body and the first flange, the junction includes a stepped portion connected to the first body, and a lateral wall connecting the stepped portion and the first flange, the bearing housing includes a second body, and a second flange extending outward from the second body, the bearing housing includes a first surface disposed on a circumferential surface of the second body, and a second surface disposed on the second flange, and the first surface is in contact with an inner surface of the first body, and the second surface is in contact with the stepped portion.

### CROSS REFERENCE TO RELATED APPLICATIONS

This application is the National Phase of PCT/KR2023/005457 filed on Apr. 21, 2023, which claims priority under 35 U.S.C. § 119(a) to Patent Application No. 10-2022-0049325, filed in the Republic of Korea on Apr. 21, 2022, all of which are hereby expressly incorporated by reference into the present application.

### TECHNICAL FIELD

Embodiments disclosed herein relate to a motor.

### BACKGROUND ART

In general, a motor uses electromagnetic interaction between a rotor and a stator to rotate the rotor. In this case, a shaft connected to the rotor is also rotated to generate a rotational driving force.

The rotor and the stator are accommodated in a housing. The housing may include a hollow cylindrical body, and a flange provided at an end portion of the body. The flange refers to an area to which an external device is fastened. Because the flange is disposed to extend outward from a main body, a junction between the body and the flange needs to have an approximately curved shape.

However, such a shape of the housing is difficult to manufacture, thereby causing problems of complicating a manufacturing process and increasing costs. Further, this shape is vulnerable to an axial load.

Meanwhile, one side of the housing is open. A bearing housing may be provided on the open side of the housing. The bearing housing includes a space in the center thereof to accommodate a bearing. The bearing housing may be press-fitted into the inside of the housing.

However, there is a problem that it is difficult to adjust the press-fitted depth of the bearing housing. Further, there is a problem that a slip occurs between the bearing housing and the housing in a direction of rotation around an axial center.

### DISCLOSURE

### Technical Problem

Accordingly, embodiments disclosed herein are to solve the foregoing problems, and an aspect of the disclosure is to provide a motor in which the rigidity of a housing is secured against the axial load, and the stability is ensured when a bearing housing is coupled to the housing.

Problems to be solved by the embodiments are not limited to the forementioned problems, and other unmentioned problems will be clearly understood from the following descriptions by those skilled in the art.

### Technical Solution

An embodiment disclosed herein may provide a motor including: a shaft; a rotor coupled to the shaft; a stator disposed corresponding to the rotor; a housing accommodating the stator; a bearing supporting the shaft and a bearing housing supporting the bearing, wherein the housing includes a first body, a first flange, and a junction connecting the first body and the first flange, the junction includes a stepped portion connected to the first body, and a lateral wall connecting the stepped portion and the first flange, the bearing housing includes a second body, and a second flange extending outward from the second body, the bearing housing includes a first surface disposed on a circumferential surface of the second body, and a second surface disposed on the second flange, and the first surface is in contact with an inner surface of the first body, and the second surface is in contact with the stepped portion.

The lateral wall may include a plurality of protruding portions protruding inward, the second flange may include a groove recessed from an edge thereof, and the protruding portion may be placed in the groove.

The protruding portion may have a curved surface, and the groove may have a curved surface corresponding to the protruding portion.

The protruding portion may be connected to the stepped portion.

The stepped portion may be disposed on a plane perpendicular to an axial direction.

The first flange may include a plurality of holes, and the protruding portion may be disposed to be aligned with the hole.

The axial length of the junction may be larger than the axial length of the first flange, and smaller than the axial length of the first body.

The shape of the stepped portion may correspond to the shape of the second flange when viewed in the axial direction.

The second flange may be disposed closer to the stator in the axial direction than the first flange.

A plurality of second flanges may have the same shape and size when viewed in the axial direction.

### Advantageous Effects

According to embodiments disclosed herein, the rigidity of a housing is secured against the axial load, and the stability is ensured when a bearing housing is coupled to the housing.

### DESCRIPTION OF DRAWINGS

FIG. 1 is a view showing a motor according to an embodiment,

FIG. 2 is a perspective view showing a bearing housing to be coupled to a housing,

FIG. 3 is a perspective view of the housing shown in FIG. 2,

FIG. 4 is a lateral cross-section view of the housing taken along line A-A in FIG. 3,

FIG. 5 is a bottom perspective view of the housing shown in FIG. 3,

FIG. 6 is a front view of the housing shown in FIG. 2,

FIG. 7 is a plan view showing the bearing housing shown in FIG. 2,

FIG. 8 is a perspective view of the bearing housing shown in FIG. 2,

FIG. 9 is a lateral cross-section view of the bearing housing taken along line B-B in FIG. 8,

FIG. 10 is a lateral cross-section view of a housing to which a bearing housing is coupled, and

FIG. 11 is a plan view of a housing to which a bearing housing is coupled.

### MODE FOR INVENTION

Below, exemplary embodiments of the disclosure will be described in detail with reference to the accompanying drawings.

However, the technical spirit of the disclosure is not limited to some embodiments to be described but may be implemented in various other forms, and one or more of the components may be selectively combined and substituted for use within the scope of the technical spirit of the disclosure.

In addition, the terms (including technical and scientific terms) used in the embodiments of the disclosure, unless specifically defined and described explicitly, may be interpreted in a meaning that may be generally understood by those having ordinary skill in the art to which the disclosure pertains, and terms that are commonly used such as terms defined in a dictionary should be able to interpret their meanings in consideration of the contextual meaning of the relevant technology.

Further, the terms used in the embodiments of the disclosure are for explaining the embodiments and are not intended to limit the disclosure.

In this specification, the singular forms also may include plural forms unless otherwise specifically stated in a phrase, and a case where at least one (or one or more) of A, B, and C is stated may include one or more of all combinations of A, B, and C.

In describing the components in the embodiments of the disclosure, terms such as first, second, A, B, (a), and (b) may be used.

Such terms are only for distinguishing the component from other component, and may not be determined by the term by the nature, sequence or procedure etc. of the corresponding constituent element.

When it is described that a component is “connected” , “coupled” or “joined” to another component, the description may include not only being directly connected, coupled or joined to the other component but also being “connected”, “coupled” or “joined” by another component between the component and the other component.

In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

A direction parallel to a longitudinal direction (vertical direction) of a shaft will be referred to as an axial direction, a direction perpendicular to the axial direction about the shaft will be referred to as a radial direction, and a direction along a circumference of a circle having a radius in the radial direction about the shaft will be referred to as a circumferential direction.

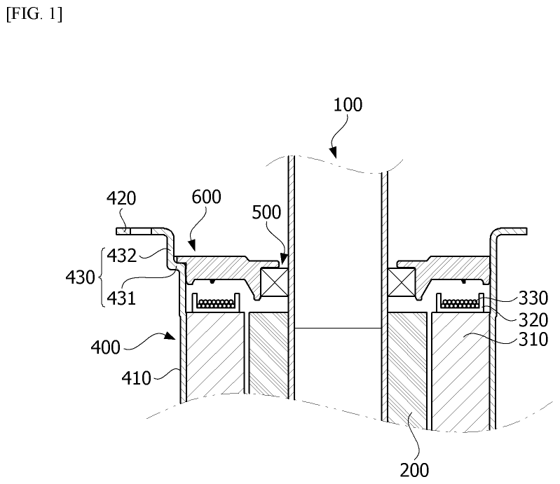

FIG. 1 is a view showing a motor according to an embodiment.

Referring to FIG. 1, the motor according to an embodiment may include a shaft 100, a rotor 200, a stator 300, a housing 400, a bearing 500, and a bearing housing 600. Hereinafter, an inward side refers to a direction from the housing 400 toward the shaft 100, i.e., the center of the motor, an outward side refers to a direction from the shaft 100 toward the housing 400, i.e., a direction opposite to the inward side. Further, the radial direction below is based on the axial center of the shaft 100.

The shaft 100 may be coupled to the rotor 200. When electromagnetic interaction occurs between the rotor 200 and the stator 300 in response to the supply of an electric current, the rotor 200 rotates and the shaft 100 rotates interlocking with the rotation of the rotor 200. The shaft 100 may be a hollow member so that a shaft of an external device can be inserted in the shaft 100.

The rotor 200 rotates based on electrical interaction with the stator 300. The rotor 200 may be disposed inside the stator 300.

The stator 300 is disposed outside the rotor 200. The stator 300 may include a stator core 310, an insulator 320 mounted to the stator core 310, and a coil 330. The coil 330 may be wound around the insulator 320. The insulator 320 is placed between the coil 330 and the stator core 310, and serves to electrically insulate the stator core 310 and the coil 330 from each other. The coil 330 causes the electrical interaction with the magnet of the rotor 200.

The housing 400 may be a hollow cylindrical member.

The bearing 500 rotatably supports the shaft 100.

The bearing housing 600 forms a space in the center thereof to accommodate the bearing 500.

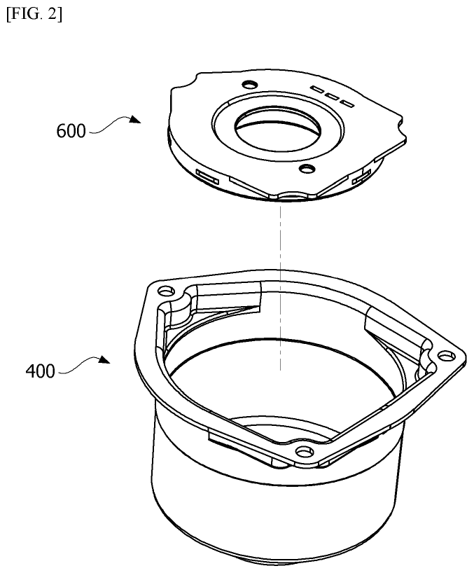

FIG. 2 is a perspective view showing the bearing housing 600 to be coupled to the housing 400.

Referring to FIG. 2, the bearing housing 600 is placed in the housing 400. The bearing housing 600 covers an open side of the housing 400. The bearing housing 600 is press-fitted into the inside of the housing 400.

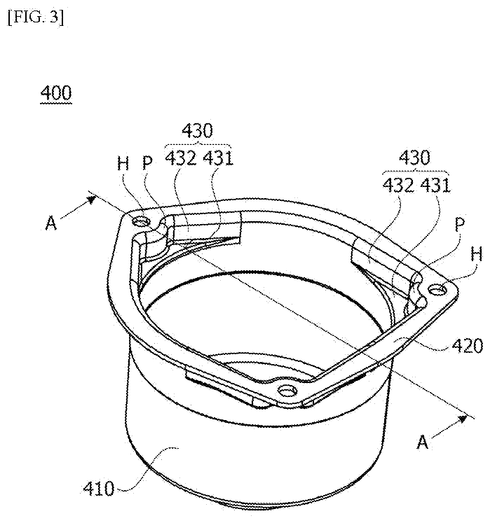

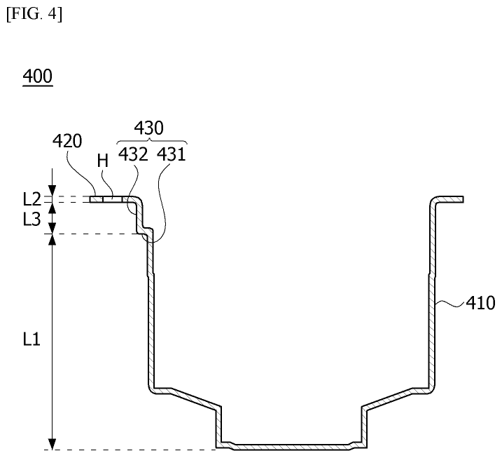

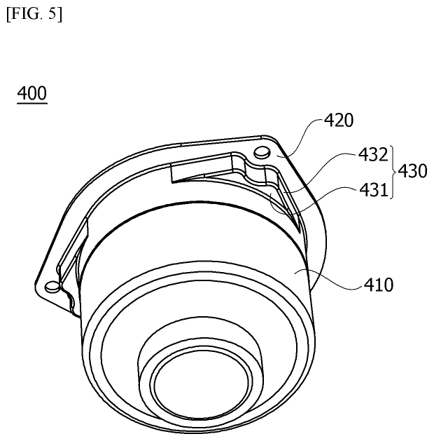

FIG. 3 is a perspective view of the housing 400 shown in FIG. 2, FIG. 4 is a lateral cross-section view of the housing 400 taken along line A-A in FIG. 3, and FIG. 5 is a bottom perspective view of the housing 400 shown in FIG. 3.

Referring to FIGS. 3 to 5, the housing 400 may include a first body 410, a first flange 420, and a junction 430.

The first body 410 is a cylindrical member. The first body 410 accommodates the rotor 200 and the stator 300 therein.

The first flange 420 is disposed at an end portion of the first body 410 and fastened to the external device. The first flange 420 is disposed to protrude from the first body 410 in the radial direction. The first flange 420 may include a plurality of holes H. The hole H allows a fastening member to pass therethrough. The first flange 420 may have an overall polygonal shape. The holes H may be located near the vertexes of the first flange 420.

The junction 430 connects the first body 410 and the first flange 420. The junction 430 may be provided between the first body 410 and the first flange 420 in the axial direction. The junction 430 serves to increase the rigidity of the housing 400 against an axial load. In particular, when the axial load is added to the housing 400 as the shaft of the external device is inserted in the shaft 100, a connecting portion between the first flange 420 and the first body 410 may be vulnerable to the axial load due to a structural difference between the first flange 420 and the first body 410. To compensate the connecting portion for the vulnerability, the junction 430 to be described later may be used.

The junction 430 may include a stepped portion 431 and a lateral wall 432. The stepped portion 431 forms an area that protrudes from the outer surface of the first body 410 in the radial direction. The stepped portion 431 may be disposed at the end of the first body 410 on a plane perpendicular to the axial direction.

A portion of the lateral wall 432 may connect the stepped portion 431 and the first flange 420. A portion of the lateral wall 432 is formed to protrude outward from the outer surface of the first body 410. The lateral wall 432 is perpendicularly connected to the stepped portion 431.

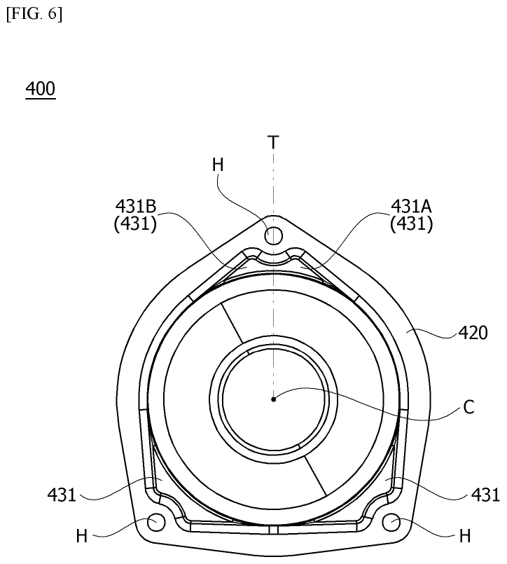

FIG. 6 is a front view of the housing 400 shown in FIG. 2,

Referring to FIGS. 3 to 6, the lateral wall 432 includes a protruding portion P. The protruding portion P protrudes toward the center C of the housing 400. The protruding portion P is disposed corresponding to the hole H. A plurality of protruding portions P may be present. The protruding portion P secures a fastening space for the first flange 420 on the outer side of the first body 410, and increases the rigidity of the lateral wall 432 against the axial load.

When viewed in the axial direction, the inner edge of the first flange 420 may have a “W”-shape based on the protruding portion P.

The protruding portion P is connected to the stepped portion 431. The protruding portion P includes a curved surface.

The stepped portion 431 is disposed around the hold H of the first flange 420. Further, the stepped portion 431 may include a first stepped portion 431A and a second stepped portion 431B. The first stepped portion 431A and the second stepped portion 431B may be disposed symmetrically with respect to a reference line T. The reference line T refers to a virtual straight line passing through the center of the hole H and the center C of the housing 400. Because the first stepped portion 431A and the second stepped portion 431B are disposed symmetrically with respect to the hole H, the fastening space for the first flange 420 is secured around the hole H, and the rigidity of the housing 400 is uniformly secured against the axial load.

The first stepped portion 431A and the second stepped portion 431B may have the same shape and size.

The first stepped portion 431A and the second stepped portion 431B are disposed on the plane perpendicular to the axial direction, and perpendicularly connected to the lateral wall 432 connected to the first flange 420. Further, the first stepped portion 431A and the second stepped portion 431B are perpendicularly connected to the first body 410. The stepped portion 431 serves to increase the rigidity of the housing 400 against the axial load.

A plurality of first and second stepped portions 431A and 431B may be present. The first stepped portion 431A and the second stepped portion 431B may be arranged as one set corresponding to the hole H disposed near the vertex of the first flange 420. The plurality of stepped portions 431 may have the same shape and size.

An axial length L3 of the junction 430 may be larger than an axial length L2 of the first flange 420, and smaller than an axial length LI of the first body 410.

When viewed in the axial direction, the area of all the stepped portions 431 is smaller than the total area of the first flange 420. If the area of all the stepped portions 431 is larger than the total area of the first flange 420, it may be rather vulnerable to the axial load.

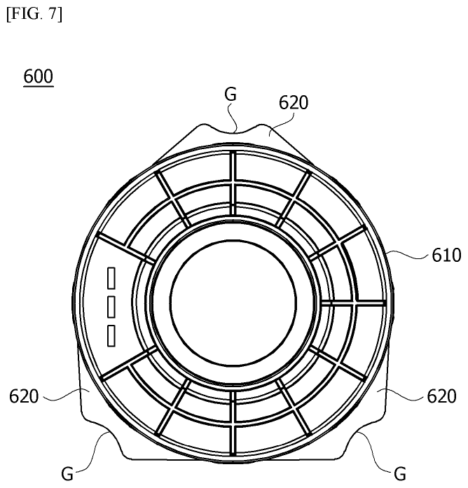

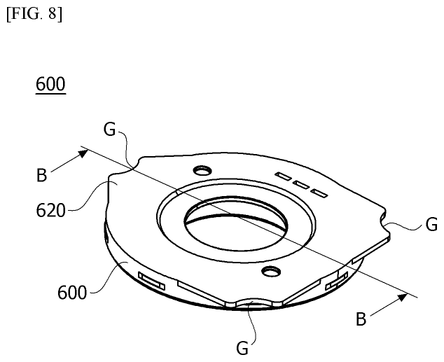

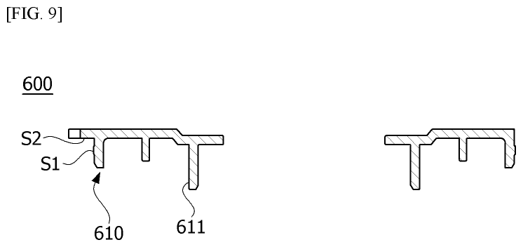

FIG. 7 is a plan view showing the bearing housing 600 shown in FIG. 2, FIG. 8 is a perspective view of the bearing housing 600 shown in FIG. 2, and FIG. 9 is a lateral cross-section view of the bearing housing 600 taken along line B-B in FIG. 8.

Referring to FIGS. 7 to 9, the bearing housing 600 may include a second body 610, and a second flange 620.

The second body 610 may be shaped like a plate having a circumferential surface.

The second flange 620 is disposed to extend outward from the second body 610. A plurality of second flanges 620 may be present. The plurality of second flanges 620 may be arranged at regular intervals along the circumference of the second body 610.

The second flange 620 includes a groove G recessed from the edge thereof.

When the bearing housing 600 is press-fitted into the housing 400, the groove G is disposed to be aligned with the protruding portion P of the housing 400. The groove G has a curved surface corresponding to the protruding portion P. When the bearing housing 600 is press-fitted into the housing 400, the protruding portion P of the housing 400 is placed in the groove G. When viewed in the axial direction, the shape of the second flange 620 corresponds to the shape of the stepped portion 431.

The plurality of second flanges 620 may have the same shape and size.

The bearing housing 600 may include an accommodating portion 611 in the center thereof to accommodate the bearing 500.

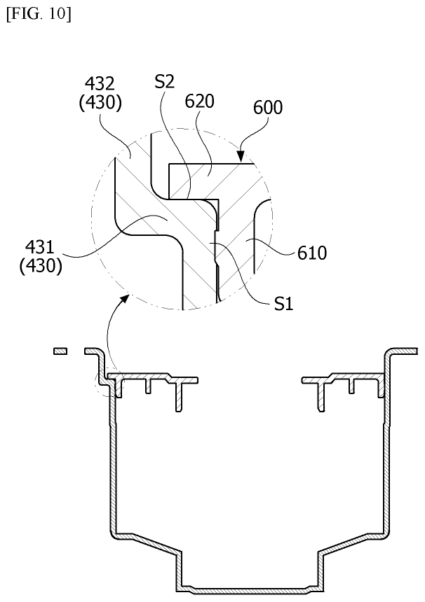

FIG. 10 is a lateral cross-section view of the housing 400 to which the bearing housing 600 is coupled.

Referring to FIG. 10, the bearing housing 600 may have a first surface SI and a second surface S2.

The first surface S1 is disposed on the circumferential surface of the second body 610. The first surface S1 comes into contact with the inner surface of the first body 410 of the housing 400 when the bearing housing 600 is press-fitted into the housing 400. The second surface S2 is disposed on the second flange 620. The second surface S2 comes into contact with the stepped portion 431 of the housing 400 when the bearing housing 600 is press-fitted into the housing 400.

The second flange 620 is disposed closer to the stator 300 in the axial direction than the first flange 610.

To assemble the bearing housing 600 and the housing 400, the bearing housing 600 may be pressed until the second surface S2 comes into contact with the stepped portion 431 of the housing 400, thereby having an advantage of maintaining a constant press-fitted depth. Further, there is an advantage that the size of the first surface SI may be adjusted to control a press-fitting force between the bearing housing 600 and the housing 400 in various ways.

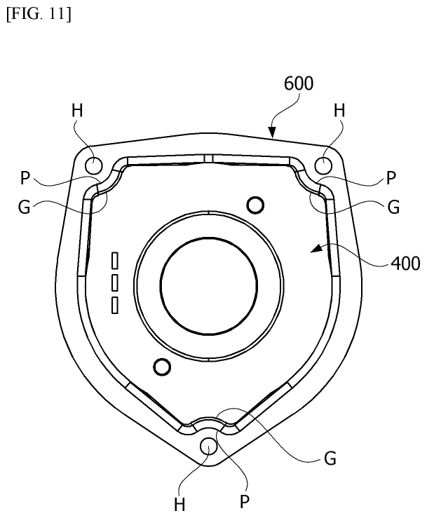

FIG. 11 is a plan view of the housing 400 to which the bearing housing 600 is coupled.

Referring to FIG. 11, when the bearing housing 600 is coupled to the housing 400, the protruding portion P of the housing 400 is placed in the groove G recessed in the radial direction. Therefore, the groove G is locked by the protruding portion P in the direction of rotation around the axial center, thereby preventing a slip from occurring between the bearing housing 600 and the housing 400.

In the foregoing embodiments, an inner rotor type motor has been described by way of example. However, the disclosure is not limited to the foregoing embodiments, but may be applied to an outer rotor type motor. In addition, the motor according to the disclosure is applicable to various devices such as vehicles or home appliances.

1.-10. (canceled)

11. A motor comprising:
a shaft;
a rotor coupled to the shaft;
a stator disposed corresponding to the rotor;
a housing accommodating the stator;
a bearing supporting the shaft; and
a bearing housing supporting the bearing,
wherein the housing comprises a first body, a first flange, and a junction connecting the first body and the first flange,
wherein the junction comprises a stepped portion connected to the first body, and a lateral wall connecting the stepped portion and the first flange, and
wherein the lateral wall comprises a plurality of protruding portions protruding inward, the second flange comprises a groove recessed from an edge thereof, and the protruding portion is placed in the groove.

12. The motor of claim 11, wherein the bearing housing comprises a second body, and a second flange extending outward from the second body,
wherein the bearing housing comprises a first surface disposed on a circumferential surface of the second body, and a second surface disposed on the second flange, and
wherein the first surface is in contact with an inner surface of the first body, and the second surface is in contact with the stepped portion.

13. The motor of claim 12, wherein the protruding portion comprises a curved surface, and the groove comprises a curved surface corresponding to the protruding portion.

14. The motor of claim 12, wherein the protruding portion is connected to the stepped portion.

15. The motor of claim 11, wherein the stepped portion is disposed on a plane perpendicular to an axial direction.

16. The motor of claim 11, wherein the first flange comprises a plurality of holes, and wherein the protruding portion is disposed to be aligned with the hole.

17. The motor of claim 11, wherein an axial length of the junction is larger than an axial length of the first flange, and smaller than an axial length of the first body.

18. The motor of claim 11, wherein a shape of the stepped portion corresponds to a shape of the second flange when viewed in axial direction.

19. The motor of claim 11, wherein the second flange is disposed closer to the stator in an axial direction than the first flange.

20. The motor of claim 11, wherein a plurality of second flanges have the same shape and size when viewed in an axial direction.
